(19) United States
(12) Patent Application Publication
(10) Pub. No.: US 2019/0381972 A1
(43) Pub. Date: Dec. 19, 2019

(54) PORTABLE DEVICE, ON-BOARD DEVICE, AND WIRELESS COMMUNICATION SYSTEM FOR VEHICLES

(71) Applicant: Panasonic Intellectual Property Management Co., Ltd., Osaka (JP)

(72) Inventors: MASAMI TAKIGAWA, Kanagawa (JP); MOTOKI ASANO, Kanagawa (JP)

(21) Appl. No.: 16/554,613

(22) Filed: Aug. 28, 2019

Related U.S. Application Data
(63) Continuation of application No. PCT/JP2018/004970, filed on Feb. 14, 2018.

(30) Foreign Application Priority Data
Mar. 8, 2017 (JP) 2017-044296
Sep. 28, 2017 (JP) 2017-187566

(51) Int. Cl. B60R 25/24; H04W 4/40; H04W 52/02; G07C 9/00; E05B 81/54

(52) U.S. Cl. CPC B60R 25/245; H04W 4/40; G07C 2009/00507; G07C 9/00309; E05B 81/54; H04W 52/0245

(57) ABSTRACT

A portable device performs two-way communication with an on-board device. The portable device has an operating circuit, a communication circuit, and a controller circuit. The operating circuit accepts an operation for stopping communication with the on-board device. The communication circuit receives a first signal from the on-board device and transmits to the on-board device a second signal including information on reception strength of the first signal and information on communication stop corresponding to the operation accepted by the operating circuit. When the reception strength of the first signal received by the communication circuit is less than or equal to a first threshold, the controller circuit causes the communication circuit to stop the communication with the on-board device.

### CROSS-REFERENCE TO RELATED APPLICATIONS

This application is a continuation application of the PCT International Application No. PCT/JP2018/004970 filed on Feb. 14, 2018, which claims the benefit of foreign priority of Japanese patent application No. 2017-044296 filed on Mar. 8, 2017 and Japanese patent application No. 2017-187566 filed on Sep. 28, 2017, the contents all of which are incorporated herein by reference.

### BACKGROUND

### 1. Technical Field

The present disclosure relates to a communication technique, in particular, to a portable device used in a vehicle, an on-board device, and a wireless communication system for vehicles.

### 2. Description of the Related Art

In a smart entry system, an electronic key receives an authentication request signal regularly transmitted from an on-board device in a vehicle and transmits an authentication response signal. When the on-board device receives this signal and succeeds in authentication of the authentication response signal, the doors are locked or unlocked. When a specific operation is performed with this electronic key, a smart entry key function is disabled (for example, refer to Unexamined Japanese Patent Publication No. 2008-223273).

### SUMMARY

The user may get out of the vehicle and perform a specific operation before locking the doors. In this case, the smart entry function is disabled by this specific operation, which is inconvenient for the user.

An object of the present disclosure is to provide a technique for ensuring convenience even when communication is stopped in a smart entry system.

A portable device according to one aspect of the present disclosure performs two-way communication with an on-board device. This portable device has an operating circuit, a communication circuit, and a controller circuit. The operating circuit accepts an operation for stopping communication with the on-board device. The communication circuit receives a first signal from the on-board device and transmits a second signal to the on-board device. The second signal includes information on reception strength of the first signal and information on communication stop corresponding to the operation accepted by the operating circuit. When the reception strength of the first signal received by the communication circuit is less than or equal to a first threshold, the controller circuit causes the communication circuit to stop the communication with the on-board device.

The on-board device according to an aspect of the present disclosure is mounted on a vehicle to perform two-way communication with the portable device. The on-board device includes a transmitter circuit, a receiver circuit, and a controller circuit. The transmitter circuit transmits the first signal to the portable device. The receiver circuit receives from the portable device the second signal including the information on the reception strength in the case where the portable device has received the first signal. When the second signal received by the receiver circuit includes the information on the stop of communication with the on-board device and when the reception strength included in the second signal received by the receiver circuit is less than or equal to the first threshold, the controller circuit causes at least one of the transmitter circuit and the receiver circuit to stop the communication with the portable device. When the reception strength of the second signal received by the receiver circuit is less than or equal to a second threshold larger than the first threshold, the controller circuit instructs the vehicle to lock the doors.

A wireless communication system for vehicles according to an aspect of the present disclosure includes: the on-board device that transmits the first signal; and the portable device that transmits to the on-board device the second signal including the information on the reception strength of the first signal received from the on-board device. When accepting an operation for stopping the communication with the on-board device from a user, the portable device transmits to the on-board device the second signal also including the information on the communication stop corresponding to the accepted operation. When the reception strength of the received first signal is less than or equal to the first threshold, the portable device stops the communication with the on-board device.

Any combinations of the above-described components and modifications of the features of the present disclosure in methods, devices, systems, recording media, and computer programs are still effective as other aspects of the present disclosure.

According to the present disclosure, it is possible to ensure convenience even when communication is stopped in a smart entry system.

### BRIEF DESCRIPTION OF DRAWINGS

FIG. 1A is a diagram illustrating an outline of smart communication performed by a wireless communication system for vehicles according to a first exemplary embodiment of the present disclosure.

FIG. 1B is a diagram illustrating a format of a search signal in the wireless communication system for vehicles illustrated in FIG. 1A.

FIG. 1C is a diagram illustrating a format of a response signal in the wireless communication system for vehicles illustrated in FIG. 1A.

FIG. 2 is a diagram illustrating a configuration of the wireless communication system for vehicles illustrated in FIG. 1A.

FIG. 3 is a sequence diagram illustrating a door locking procedure performed by the wireless communication system for vehicles illustrated in FIG. 2.

FIG. 4 is a sequence diagram illustrating a smart communication stop procedure performed by the wireless communication system for vehicles illustrated in FIG. 2.

FIG. 5 is a flowchart illustrating a smart communication stop procedure performed by a portable device in the wireless communication system for vehicles illustrated in FIG. 2.

FIG. 6 is a flowchart illustrating a smart communication stop procedure performed by an on-board device in the wireless communication system for vehicles illustrated in FIG. 2.

FIG. 7 is a sequence diagram illustrating another smart communication stop procedure performed by the wireless communication system for vehicles illustrated in FIG. 2.

FIG. 8 is a sequence diagram illustrating still another smart communication stop procedure performed by the wireless communication system for vehicles illustrated in FIG. 2.

FIG. 9A is a diagram illustrating an outline of smart communication performed by a wireless communication system for vehicles according to a second exemplary embodiment of the present disclosure.

FIG. 9B is a diagram illustrating a format of a search signal in the wireless communication system for vehicles illustrated in FIG. 9A.

FIG. 9C is a diagram illustrating a format of a response signal in the wireless communication system for vehicles illustrated in FIG. 9A.

FIG. 10A is a diagram illustrating an outline of keyless communication performed by the wireless communication system for vehicles according to the second exemplary embodiment of the present disclosure.

FIG. 10B is a diagram illustrating a format of a keyless signal in the wireless communication system for vehicles illustrated in FIG. 10A.

FIG. 11 is a diagram illustrating a configuration of the wireless communication system for vehicles illustrated in FIG. 9A.

FIG. 12 is a sequence diagram illustrating a smart communication stop procedure performed by the wireless communication system for vehicles illustrated in FIG. 11.

FIG. 13 is a flowchart illustrating a smart communication stop procedure performed by a portable device in the wireless communication system for vehicles illustrated in FIG. 11.

FIG. 14 is a flowchart illustrating a smart communication stop procedure performed by an on-board device in the wireless communication system for vehicles illustrated in FIG. 11.

### DETAILED DESCRIPTION OF PREFERRED EMBODIMENTS

### First Exemplary Embodiment

Prior to specific description of the first exemplary embodiment according to the present disclosure, an outline of the first exemplary embodiment will be described. The present exemplary embodiment relates to a wireless communication system for vehicles that performs wireless communication for locking or unlocking doors of a vehicle between an on-board device mounted on the vehicle and a portable device (electronic key) carried by a user. In the wireless communication system for vehicles that performs wireless communication between the on-board device and the portable device, two kinds of communication sequences are defined. A first kind of the communication sequence is a communication sequence for performing two-way communication between the on-board device and the portable device, which is called “smart communication”. The smart communication is used in the smart entry function described above. A second kind of the communication sequence is a communication sequence for performing one-way communication from the portable device to the on-board device, which is called “keyless communication”. Hereinafter, the smart communication will be described.

The smart communication in the portable device may be required to stop for the purposes of suppressing battery consumption in the portable device and taking a measure against relay attack. However, when the user gets out of the vehicle and performs a specific operation before locking the doors, the smart communication is stopped by the specific operation, which causes convenience to the user as described above. In the wireless communication system for vehicles according to the first exemplary embodiment, the smart communication is stopped only when the specific operation is performed on the portable device and then the user with the portable device gets away from the vehicle so that, even if the user performs the specific operation, when the user is located near the vehicle, the smart communication is not stopped.

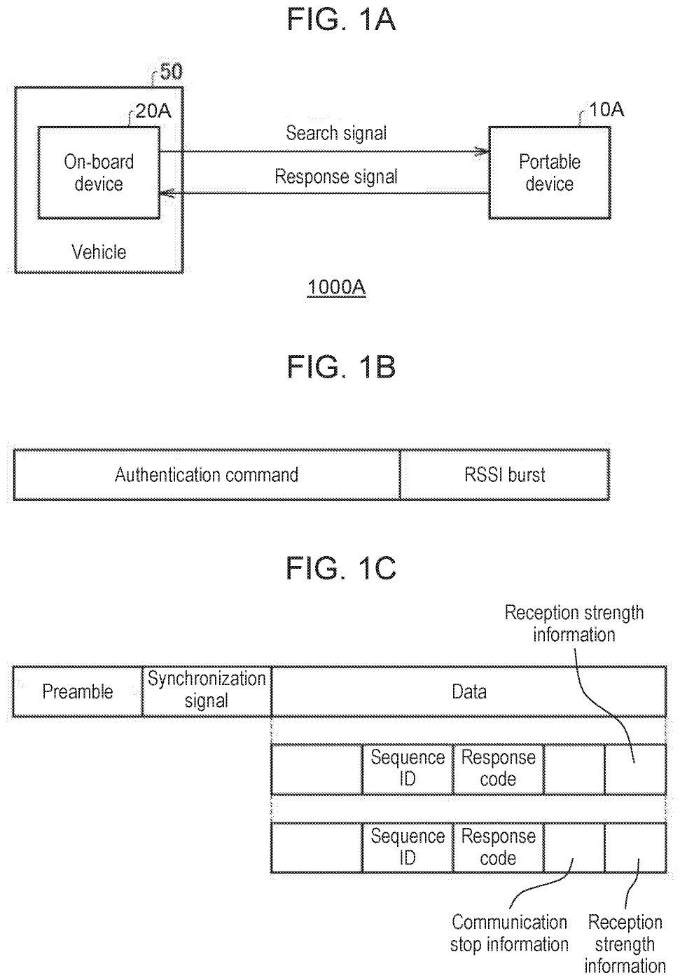

FIGS. 1A to 1C illustrate an outline of the smart communication performed by wireless communication system for vehicles 1000A. The smart communication is also referred to as a smart entry system, a smart key system, or a passive keyless entry (PKE) system. FIG. 1A illustrates a locking operation performed by wireless communication system for vehicles 1000A. Wireless communication system for vehicles 1000A includes portable device 10A and on-board device 20A. On-board device 20A is mounted on vehicle 50. When getting out of vehicle 50, the user stops an engine or a motor of vehicle 50, opens a door, and closes the door after getting off vehicle 50. With a series of actions of stopping the engine or the motor of vehicle 50, opening the door, and closing the door as a trigger, on-board device 20A transmits a search signal to portable device 10A. The search signal is a signal of a low frequency (LF), for example, a signal of a 125 kHz band. A communication distance of the signal of LF is limited to a range of approximately 2 m from vehicle 50.

FIG. 1B illustrates a format of the search signal. In the search signal, an authentication command and a burst for a received signal strength indicator (RSSI) are disposed in this order. The authentication command includes a key ID for identifying portable device 10A, a functional command to be executed by the smart communication, for example, a functional command for instructing for locking the doors, and others. The key ID is an ID for identifying portable device 10A in the smart communication. Further, the authentication command is encrypted. The burst for the RSSI is a signal for causing portable device 10A to measure strength of a received signal.

As illustrated in FIG. 1A, upon receipt of the search signal from on-board device 20A, portable device 10A measures the reception strength of the received search signal, for example, RSSI, and decrypts the content of the authentication command. When recognizing that the received signal is the search signal from the authenticated on-board device 20A based on the key ID included in the authentication command, portable device 10A transmits to on-board device 20A a response signal including the reception strength of the search signal (reception strength information) as a measurement result. The response signal is a signal of an ultra high frequency (UHF), for example, a signal of a 300 MHz band. Note that the signal of the UHF is also referred to as a signal of a radio frequency (RF).

FIG. 1C illustrates a format of the response signal. The response signal disposes a preamble, a synchronization signal, and data in this order. The preamble and the synchronization signal are known signals used for establishing communication (smart communication) between portable device 10A and on-board device 20A. The data includes a sequence ID code, a response code, and the reception strength information. The sequence ID is an ID for identifying a combination of on-board device 20A and portable device 10A (identification code), which is associated with the key ID. The response code is information for indicating that this signal corresponds to the authentication command. Any publicly known technique is applicable to those codes, and therefore, description of those codes will be omitted herein. The lowest-stage format will be described later.

As illustrated in FIG. 1A, on-board device 20A receives the response signal from portable device 10A. On-board device 20A determines whether a response to the already transmitted search signal has been received from portable device 10A, based on the sequence ID and the response code included in the response signal. When determining that the response signal has been received from portable device 10A, on-board device 20A compares the reception strength of the search signal included in the reception strength information with a threshold. When the reception strength of the search signal in portable device 10A is greater than the threshold, on-board device 20A transmits again the search signal to portable device 10A. According to this, on-board device 20A receives again the response signal from portable device 10A. On the other hand, the reception strength of the search signal in portable device 10A is less than or equal to the threshold, on-board device 20A locks the doors of vehicle 50.

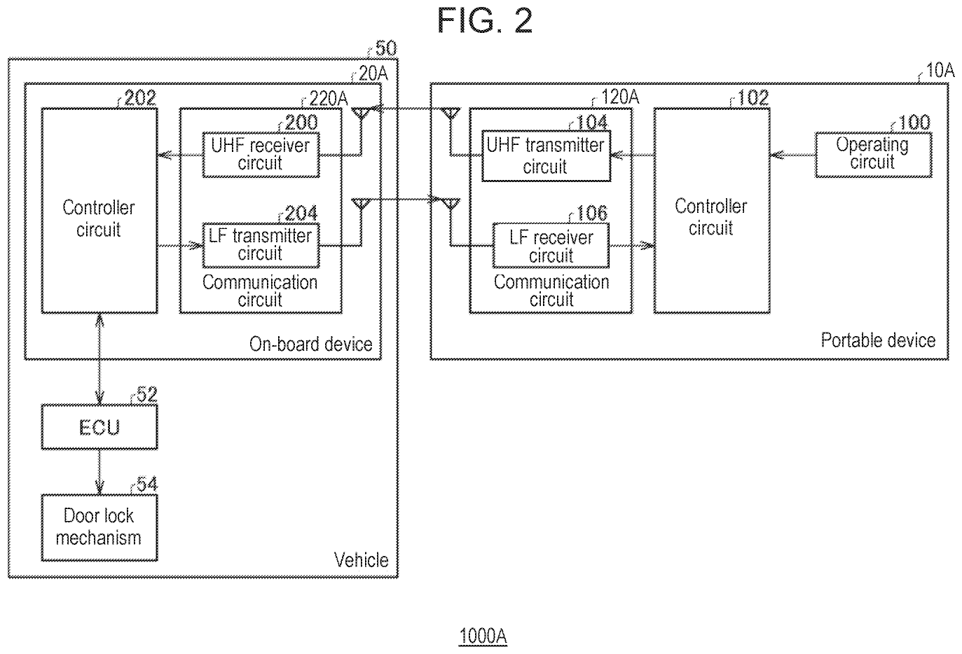

FIG. 2 is a functional block diagram illustrating a configuration of wireless communication system for vehicles 1000A. Wireless communication system for vehicles 1000A includes portable device 10A and on-board device 20A as described above. On-board device 20A is mounted on vehicle 50. Portable device 10A includes operating circuit 100, controller circuit 102, and communication circuit 120A. Communication circuit 120A includes UHF transmitter circuit 104 and LF receiver circuit 106. On-board device 20A includes controller circuit 202 and communication circuit 220A. Communication circuit 220A includes UHF receiver circuit 200 and LF transmitter circuit 204. Vehicle 50 includes electronic control unit (ECU) 52 and door lock mechanism 54.

Next, (1) a process of locking the doors, (2) a process of stopping smart communication after the locking of the doors, and (3) a process of canceling the stop of the smart communication will be described in this order.

(1) Process of Locking the Doors

A sensor (not illustrated) mounted in vehicle 50 detects a series of actions of stopping the engine or motor in vehicle 50, opening the door, and closing the door. Upon receipt of notification of detection of the series of actions from the sensor, ECU 52 outputs the detection of the actions to controller circuit 202. Upon receipt of the detection of the actions from ECU 52, controller circuit 202 determines to transmit a search signal in smart communication and generates the search signal. At that time, the authentication command includes a key ID for identifying portable device 10A. Controller circuit 202 outputs the generated search signal to LF transmitter circuit 204. LF transmitter circuit 204 transmits the search signal to portable device 10A.

LF receiver circuit 106 of portable device 10A receives the search signal from on-board device 20A, and outputs the search signal to controller circuit 102. Controller circuit 102 extracts the key ID included in the search signal. Controller circuit 102 executes pair authentication based on a key ID retained in advance and the extracted key ID. When the pair authentication fails, a process described below is not executed. On the other hand, when the pair authentication succeeds, controller circuit 102 generates a response signal. At that time, controller circuit 102 includes reception strength information on the reception strength of the search signal measured by LF receiver circuit 106 in the response signal. The response signal is as illustrated in the second stage of FIG. 1C. Controller circuit 102 outputs the response signal to UHF transmitter circuit 104. UHF transmitter circuit 104 transmits the response signal to on-board device 20A. This action is equivalent to transmitting to on-board device 20A the response signal including the information on the reception strength of the search signal as a response to the search signal received from on-board device 20A. When the search signal is called as first signal, the response signal is called second signal.

UHF receiver circuit 200 of on-board device 20A receives the response signal from portable device 10A. When UHF receiver circuit 200 has not received a response signal for a specific period after the transmission of the search signal from LF transmitter circuit 204, controller circuit 202 may cause LF transmitter circuit 204 to transmit again the same search signal. UHF receiver circuit 200 outputs the response signal to controller circuit 202. Controller circuit 202 recognizes that a response to the already transmitted search signal has been received from portable device 10A, based on the sequence ID and the response code included in the response signal. In that case, controller circuit 202 extracts the reception strength information included in the response signal, and compares the reception strength of the search signal in portable device 10A with the threshold. When the reception strength of the search signal in portable device 10A is greater than the threshold, controller circuit 202 determines to transmit again the search signal to portable device 10A. In that case, controller circuit 202 instructs LF transmitter circuit 204 to transmit again the search signal. LF transmitter circuit 204 repeats the same actions as described above. As a result, UHF receiver circuit 200 receives again the response signal from portable device 10A, and controller circuit 202 also repeats the same actions as described above.

On the other hand, when the reception strength of the search signal in portable device 10A is less than or equal to the threshold, controller circuit 202 determines to lock the doors of vehicle 50. Accordingly, the threshold is set to a value corresponding to a distance at which the user is to get away from vehicle 50 to lock the doors. When determining to lock the doors, controller circuit 202 locks door lock mechanism 54 via ECU 52.

(2) Process of Stopping Smart Communication after the Locking of the Doors

Operating circuit 100 of portable device 10A corresponds to a button used in keyless communication, for example, which is depressed when the user requests for locking or unlocking the doors of vehicle 50. Descriptions of the keyless communication will be omitted here. The user executes an operation of a predetermined pattern on operating circuit 100 in vehicle 50 or after getting out of vehicle 50. Operating circuit 100 accepts an operation of a predetermined first pattern. An example of the operation of the first pattern is depressing a button for unlocking and a button for locking at the same time. Operating circuit 100 notifies of controller circuit 102 that the operation of the first pattern has been accepted. Another example of the operation of the first pattern may be to alternately depress the button for unlocking and the button for locking five or more times. The button used in the keyless communication may be depressing a dedicated button for stopping the keyless communication or canceling the stop.

When controller circuit 202 of on-board device 20A receives detection of the series of actions in the same manner as described above, LF transmitter circuit 204 transmits a search signal to portable device 10A. When LF receiver circuit 106 of portable device 10A receives the search signal from on-board device 20A, controller circuit 102 generates a response signal in the same manner as described above. When accepting the operation of the first pattern, controller circuit 102 includes information on stop of the smart communication (hereinafter, called “communication stop information”) in the response signal. The response signal is illustrated in the lowest stage of FIG. 1C. Controller circuit 102 outputs the response signal to UHF transmitter circuit 104. UHF transmitter circuit 104 transmits the response signal to on-board device 20A.

On the other hand, when accepting the operation of the first pattern, controller circuit 102 compares measured reception strength of the search signal with a threshold. This threshold is a threshold for the user to, after getting away from vehicle 50 to lock the doors of vehicle 50, further getting away from vehicle 50 to stop the smart communication. Accordingly, the threshold is set to a value smaller than the threshold for determining whether to lock the doors. Hereinafter, the threshold for stopping the smart communication will be called first threshold, and the threshold for determining whether to lock the doors will be called second threshold. That is, the first threshold is smaller than the second threshold.

When the reception strength of the received search signal is less than or equal to the first threshold, controller circuit 102 causes communication circuit 120A to stop the communication (smart communication) with on-board device 20A. When the reception strength of the received search signal is less than or equal to the first threshold, controller circuit 102 causes UHF transmitter circuit 104 to transmit the response signal and then causes communication circuit 120A to stop the communication with on-board device 20A. When the reception strength of the received search signal is greater than the first threshold, controller circuit 102 executes no processing. When LF receiver circuit 106 repeatedly receives the search signal from on-board device 20A, controller circuit 102 repeatedly executes the foregoing processing.

UHF receiver circuit 200 of on-board device 20A receives the response signal from portable device 10A. UHF receiver circuit 200 outputs the response signal to controller circuit 202. When the response signal includes the communication stop information, controller circuit 202 compares the reception strength of the search signal included as reception strength information in the response signal with the second threshold, and also compares the reception strength of the search signal with the first threshold. The first threshold corresponds to the first threshold in on-board device 20A for stopping the smart communication. The first threshold in on-board device 20A is set to be identical to the first threshold in portable device 10A for stopping the smart communication. Accordingly, also in on-board device 20A, the first threshold is set to be smaller than the second threshold. Controller circuit 202 may execute the comparison between the reception strength of the search signal and the first threshold after the reception strength of the search signal included in the response signal becomes less than or equal to the second threshold.

When the reception strength of the search signal included in the response signal is greater than the first threshold, controller circuit 202 determines to transmit again the search signal to portable device 10A. In that case, controller circuit 202 instructs LF transmitter circuit 204 to transmit again the search signal. LF transmitter circuit 204 repeats the same actions as described above. As a result, UHF receiver circuit 200 receives again the response signal from portable device 10A, and controller circuit 202 also repeats the same actions as described above. On the other hand, when the reception strength of the search signal included in the response signal is less than or equal to the first threshold, controller circuit 202 causes communication circuit 220A to stop the communication with on-board device 20A.

In the present exemplary embodiment, the communication of communication circuit 120A is stopped in portable device 10A, and the communication of communication circuit 220A is stopped in on-board device 20A. However, the operation of one of UHF transmitter circuit 104 and LF receiver circuit 106 in communication circuit 120A may be stopped and the operation of one of UHF receiver circuit 200 and LF transmitter circuit 204 in communication circuit 220A may be stopped. For example, the transmission of UHF transmitter circuit 104 and the transmission of LF transmitter circuit 204 may be stopped.

(3) Process of Canceling the Stop of the Smart Communication

In the process of canceling the stop of the smart communication by portable device 10A, operating circuit 100 of portable device 10A accepts an operation of a second pattern that is predetermined and different from the first pattern. Operating circuit 100 notifies of controller circuit 102 that the operation of the second pattern has been accepted. Upon receipt of the notification from operating circuit 100, controller circuit 102 operates communication circuit 120A. The second pattern may be the same as the first pattern for stopping the smart communication. In this case, at each acceptance of the operation of the predetermined same pattern, the stop of the smart communication and the cancel of the stop of the smart communication are alternately repeated.

Meanwhile, to cancel the stop of the smart communication of on-board device 20A, the following actions can be considered, for example. That is, when the user unlocks door lock mechanism 54 by inserting a mechanical key of portable device 10A into a key hole in vehicle 50 and turning the mechanical key, the stop of the smart communication by communication circuit 220A in on-board device 20A is canceled.

In addition, to cancel the stop of the smart communication between portable device 10A and on-board device 20A at the same time, the following actions can be considered, for example. That is, when the user gets in vehicle 50 and minute authentication is performed through immobilizer communication to start the engine, the stop of the smart communication between communication circuit 120A in portable device 10A and communication circuit 220A in on-board device 20A is canceled.

The configuration of controllers circuit 102 and 202 can be implemented in hardware by a processor (central processing unit), a memory, and other large scale integration (LSI) in an arbitrary computer, and can be implemented in software by a program loaded and stored in the memory. FIG. 2 illustrates functional blocks realized by the cooperation of these components. Hence, these functional blocks can be implemented in various forms by hardware alone or by combinations of hardware and software.

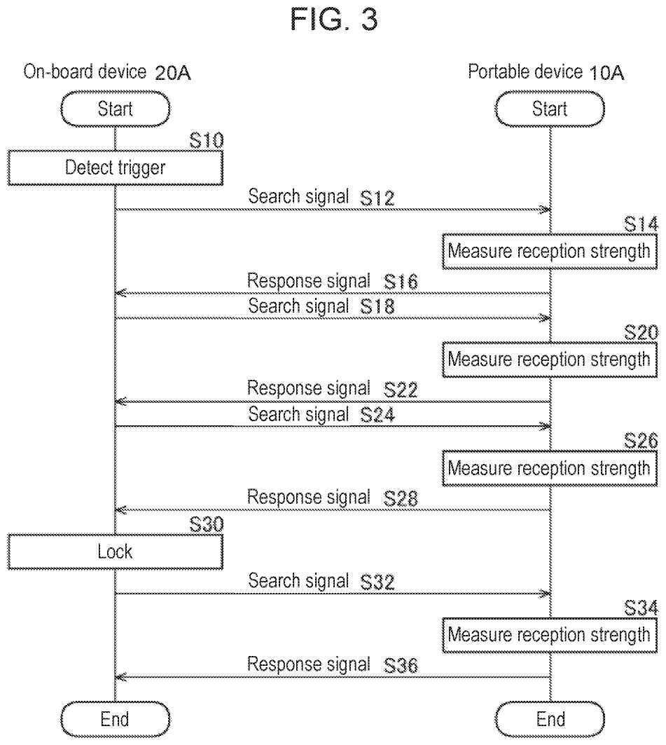

Operations of thus configured wireless communication system for vehicles 1000A will be described. FIG. 3 is a sequence diagram illustrating a door lock procedure performed by wireless communication system for vehicles 1000A. On-board device 20A detects a trigger for transmitting a search signal to portable device 10A (S10), and transmits the search signal to portable device 10A (S12). Portable device 10A measures reception strength of the search signal from on-board device 20A (S14), and transmits a response signal including information on the measured reception strength of the search signal (reception strength information) to on-board device 20A (S16). Upon receipt of the response signal, on-board device 20A transmits a search signal to portable device 10A (S18). Portable device 10A measures reception strength of the search signal from on-board device 20A (S20), and transmits a response signal including the reception strength information to on-board device 20A (S22).

On-board device 20A transmits a search signal to portable device 10A (S24). Portable device 10A measures reception strength of the search signal from on-board device 20A (S26). Portable device 10A transmits a response signal including the reception strength information to on-board device 20A (S28). When the reception strength of the search signal is less than or equal to a second threshold, on-board device 20A locks door lock mechanism 54 (S30), and transmits a search signal to portable device 10A (S32). Portable device 10A measures reception strength of the search signal from on-board device 20A (S34). Portable device 10A transmits a response signal including the reception strength information to on-board device 20A (S36).

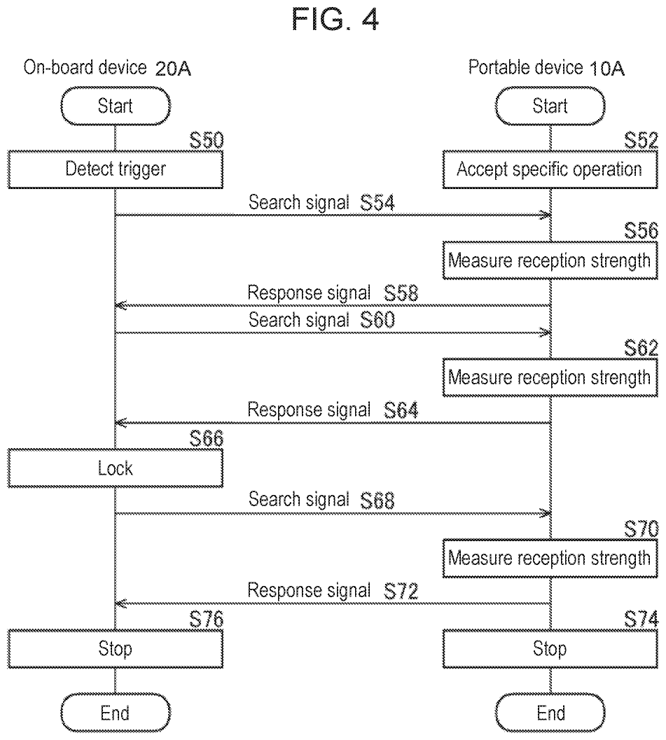

FIG. 4 is a sequence diagram illustrating a smart communication stop procedure performed by wireless communication system for vehicles 1000A. On-board device 20A detects a trigger for transmitting a search signal to portable device 10A (S50). Portable device 10A accepts a specific operation for stopping the smart communication (S52). On-board device 20A transmits a search signal to portable device 10A (S54). Portable device 10A measures reception strength of the search signal from on-board device 20A (S56). Portable device 10A transmits a response signal including information on the measured reception strength of the search signal (reception strength information) and communication stop information based on the accepted specific operation to on-board device 20A (S58). On-board device 20A transmits a search signal to portable device 10A (S60). Portable device 10A measures reception strength of the search signal from on-board device 20A (S62). Portable device 10A transmits a response signal including the reception strength information and the communication stop information to on-board device 20A (S64).

When the reception strength of the search signal included in the response signal is less than or equal to the second threshold, on-board device 20A locks door lock mechanism 54 (S66). On-board device 20A transmits a search signal to portable device 10A (S68). Portable device 10A measures reception strength of the search signal from on-board device 20A (S70). Portable device 10A transmits a response signal including the reception strength information and the communication stop information to on-board device 20A (S72). When the reception strength of the search signal is less than or equal to the first threshold, portable device 10A transmits a response signal to on-board device 20A and then stops the smart communication (S74). On the other hand, on-board device 20A receives the response signal from portable device 10A and then stops the smart communication (S76).

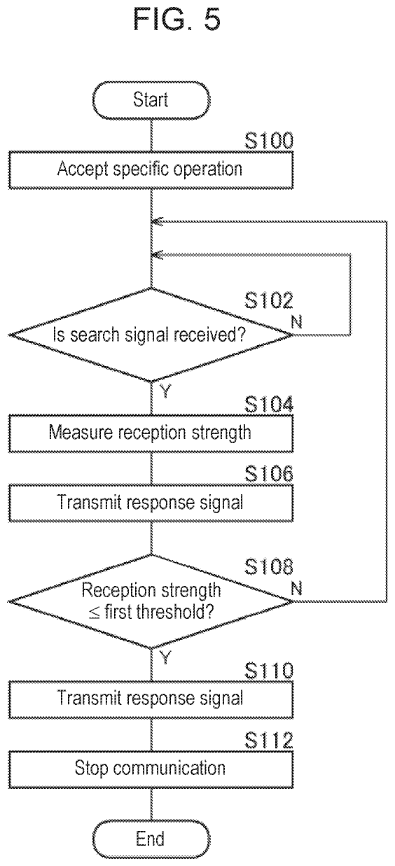

FIG. 5 is a flowchart illustrating a smart communication stop procedure performed by portable device 10A. Operating circuit 100 accepts a specific operation for stopping the smart communication (S100). When not receiving a search signal from on-board device 20A (N in S102), LF receiver circuit 106 goes on standby. On the other hand, when receiving a search signal from on-board device 20A (Y in S102), LF receiver circuit 106 measures reception strength of the received search signal (S104). UHF transmitter circuit 104 transmits a response signal including information on the measured reception strength of the search signal (reception strength information) and communication stop information based on the accepted specific operation (S106). When the reception strength of the received search signal is not less than or equal to the threshold (first threshold) (N in S108), the process returns to S102. When the reception strength of the received search signal is less than or equal to the threshold (Y in S108), UHF transmitter circuit 104 transmits a response signal (S110), and controller circuit 102 causes communication circuit 120A to stop the smart communication (S112).

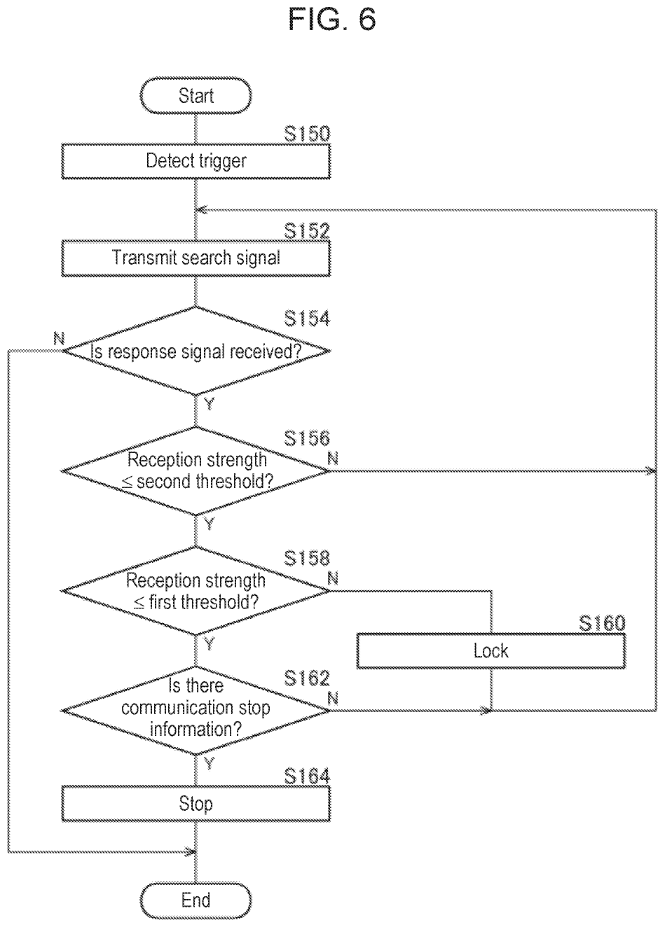

FIG. 6 is a flowchart illustrating a smart communication stop procedure performed by on-board device 20A. Controller circuit 202 detects a trigger for transmitting a search signal to portable device 10A (S150). LF transmitter circuit 204 transmits a search signal (S152). When UHF receiver circuit 200 receives a response signal from portable device 10A (Y in S154), if reception strength of the search signal included in the received response signal is not less than or equal to the second threshold (N in S156), the process returns to S152. When the reception strength of the search signal included in the response signal is less than or equal to the second threshold (Y in S156) and is not less than or equal to the first threshold (N in S158), controller circuit 202 determines to lock door lock mechanism 54 (S160) and the process returns to S152. When the reception strength of the search signal included in the response signal is less than or equal to the first threshold (Y in S158) and no communication stop information is included in the response signal (N in S162), the process returns to S152. When the communication stop information is included in the response signal (Y in S162), controller circuit 202 causes communication circuit 220A to stop the smart communication (S164). When UHF receiver circuit 200 receives no response signal (N in S154), the process is terminated.

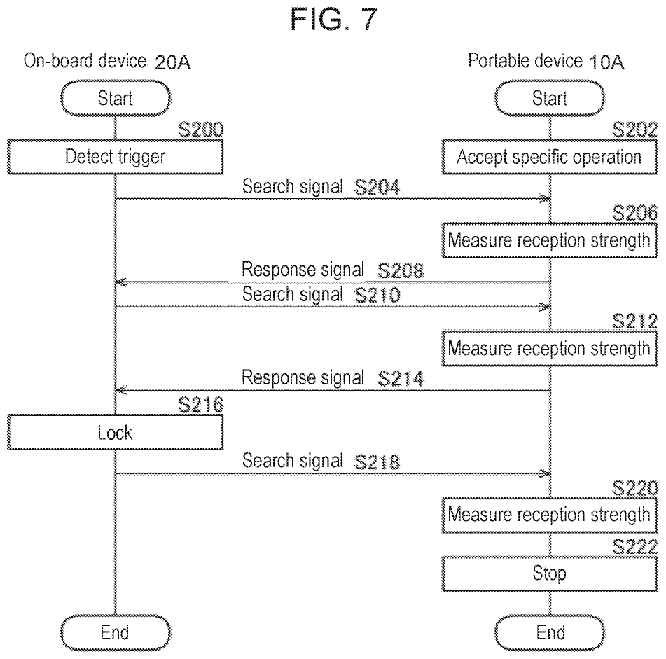

As described above, portable device 10A and on-board device 20A stop the smart communication. However, only either portable device 10A or on-board device 20A may stop the smart communication. Hereinafter, a case in which only portable device 10A is to stop the smart communication will be described. In this case, even when detecting that the reception strength of the received search signal is less than or equal to the threshold (first threshold), controller circuit 102 of portable device 10A does not need to transmit a response signal to on-board device 20A. FIG. 7 is a sequence diagram illustrating another smart communication stop procedure performed by wireless communication system for vehicles 1000A. On-board device 20A detects a trigger for transmitting a search signal to portable device 10A (S200). Portable device 10A accepts a specific operation for stopping the smart communication (S202). On-board device 20A transmits a search signal to portable device 10A (S204). Portable device 10A measures reception strength of the search signal from on-board device 20A (S206). Portable device 10A transmits a response signal including information on the measured reception strength of the search signal (reception strength information) and communication stop information based on the accepted specific operation to on-board device 20A (S208).

On-board device 20A transmits a search signal to portable device 10A (S210). Portable device 10A measures reception strength of the search signal from on-board device 20A (S212). Portable device 10A transmits a response signal including the reception strength information and the communication stop information to on-board device 20A (S214). When the reception strength of the search signal included in the response signal is less than or equal to the threshold (second threshold), on-board device 20A locks door lock mechanism 54 (S216). On-board device 20A transmits a search signal to portable device 10A (S218). Portable device 10A measures reception strength of the search signal from on-board device 20A (S220). When the reception strength of the received search signal is less than or equal to the threshold (first threshold), portable device 10A stops the smart communication without transmitting a response signal to on-board device 20A (S222).

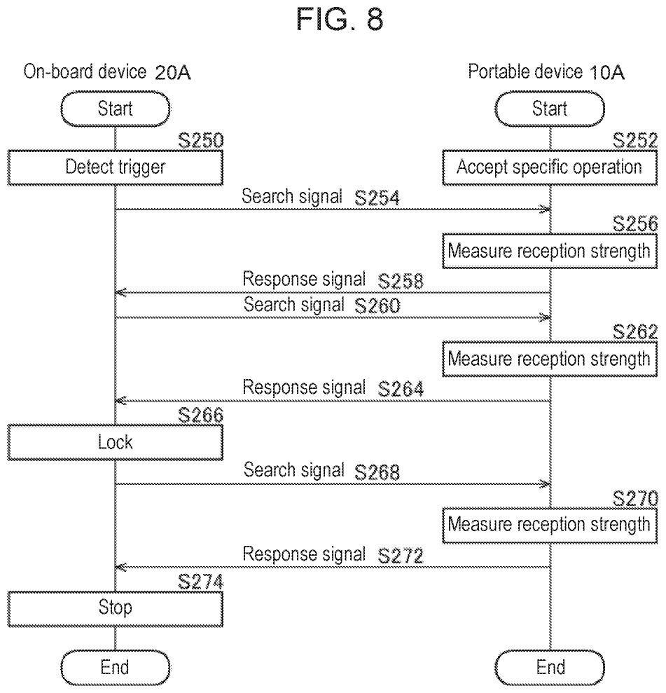

Next, a case in which only on-board device 20A is to stop the smart communication will be described. FIG. 8 is a sequence diagram illustrating still another smart communication stop procedure performed by wireless communication system for vehicles 1000A. On-board device 20A detects a trigger for transmitting a search signal to portable device 10A (S250). Portable device 10A accepts a specific operation for stopping the smart communication (S252). On-board device 20A transmits a search signal to portable device 10A (S254). Portable device 10A measures reception strength of the search signal from on-board device 20A (S256). Portable device 10A transmits a response signal including information on the measured reception strength of the search signal (reception strength information) and communication stop information based on the accepted specific operation to on-board device 20A (S258). On-board device 20A transmits a search signal to portable device 10A (S260). Portable device 10A measures reception strength of the search signal from on-board device 20A (S262). Portable device 10A transmits a response signal including the reception strength information and the communication stop information to on-board device 20A (S264).

When the reception strength of the search signal included in the response signal is less than or equal to the threshold (second threshold), on-board device 20A locks door lock mechanism 54 (S266). On-board device 20A transmits a search signal to portable device 10A (S268). Portable device 10A measures reception strength of the search signal from on-board device 20A (S270). Portable device 10A transmits a response signal including the reception strength information and the communication stop information to on-board device 20A (S272). When the reception strength of the search signal included in the response signal is less than or equal to the threshold (first threshold), on-board device 20A stops the smart communication (S274).

According to the present exemplary embodiment, the communication (smart communication) between portable device 10A and on-board device 20A is stopped when the reception strength of the search signal is less than or equal to the first threshold, thereby making it possible to stop the communication after the user has got away from vehicle 50. The communication between portable device 10A and on-board device 20A is stopped after the user has got away from vehicle 50, thereby making it possible to ensure user convenience even when the communication is stopped. The communication with on-board device 20A is stopped after portable device 10A has transmitted a response signal, thereby making it possible to notify the reception strength of the search signal to on-board device 20A. The reception strength of the search signal is notified to on-board device 20A, thereby making it possible to cause on-board device 20A to execute a process using the reception strength of the search signal. The first threshold is smaller than the second threshold for locking the doors, thereby making it possible to stop the communication after locking the doors. The communication is stopped after locking the doors, thereby making it possible to ensure the convenience even when the communication is stopped.

A portable device according to a first aspect of the present disclosure transmits to an on-board device, as a response to a first signal received from the on-board device, a second signal including information on reception strength of the first signal. The portable device has an operating circuit, a communication circuit, and a controller circuit. The operating circuit accepts an operation for stopping communication with the on-board device from a user. When the operating circuit accepts the operation, the communication circuit transmits to the on-board device a second signal also including information on communication stop according to the operation accepted by the operating circuit. When the reception strength of the first signal received by the communication circuit is less than or equal to the first threshold, the controller circuit causes the communication circuit to stop the communication with the on-board device.

According to this aspect, the communication with the on-board device is stopped when the reception strength of the first signal is less than or equal to the threshold, thereby making it possible to ensure the convenience even when the communication is stopped.

When the reception strength of the first signal received by the communication circuit is less than or equal to the threshold, the controller circuit may cause the communication circuit to transmit the second signal including information on the reception strength and then cause the communication circuit to stop the communication with the on-board device. In this case, the communication with the on-board device is stopped after the transmission of the second signal, thereby making it possible to notify the on-board device of the reception strength.

The first threshold in the controller circuit is smaller than the second threshold for the reception strength of the first signal for the vehicle equipped with the on-board device to lock the doors. The first threshold is smaller than the second threshold, thereby making it possible to stop the communication after locking the doors.

The on-board device according to the first aspect of the present disclosure includes a transmitter circuit, a receiver circuit, and a controller circuit. The transmitter circuit transmits the first signal to the portable device. As a response to the first signal transmitted from the transmitter circuit, the receiver circuit receives from the portable device the second signal including the information on the reception strength in the case where the portable device has received the first signal. When the reception strength included in the second signal received by the receiver circuit is less than or equal to the second threshold, the controller circuit instructs the vehicle to lock the doors. In the case where the second signal received by the receiver circuit includes information on stop of communication with the on-board device, when the reception strength included in the second signal received by the receiver circuit is less than or equal to the first threshold smaller than the second threshold, the controller circuit causes at least one of the transmitter circuit and the receiver circuit to stop the communication with the portable device.

According to this aspect, the communication is stopped after locking the doors, thereby making it possible to ensure the convenience even when the communication is stopped.

A wireless communication system for vehicles according to the first aspect of the present disclosure includes: the on-board device that transmits the first signal; and the portable device that transmits to the on-board device the second signal including information on the reception strength of the first signal received from the on-board device. When accepting an operation for stopping the communication with the on-board device, the portable device transmits to the on-board device the second signal also including the information on the communication stop according to the accepted operation. When the reception strength of the received first signal is less than or equal to the first threshold, the portable device stops the communication with the on-board device.

According to this aspect, the communication with the on-board device is stopped when the reception strength of the first signal is less than or equal to the first threshold, thereby making it possible to ensure the convenience even when the communication is stopped.

In the vehicle equipped with the on-board device, the doors of the vehicle are locked when the reception strength of the first signal included in the second signal received by the on-board device is less than or equal to the second threshold. The first threshold in the portable device is smaller than the second threshold. In this case, the first threshold is smaller than the second threshold for locking the doors, thereby making it possible to stop the communication after locking the doors.

### Second Exemplary Embodiment

Prior to a specific description of a second exemplary embodiment of the present disclosure, the reason why the second exemplary embodiment has been devised and an outline of the second exemplary embodiment will be described.

While the user carries an electronic key in a bag or a pocket, the electronic key may contact other stuffs so that a specific operation is performed. As a result, the smart entry function is stopped without the user's intent. Accordingly, the user cannot use the smart entry function when he or she wishes to use the smart entry function. On that occasion, the user needs to perform an operation of enabling the smart entry function, which is inconvenient for the user.

The second exemplary embodiment has been made in view of the above-mentioned circumstance and an object of the second exemplary embodiment is to provide a technique for suppressing the occurrence of an unintended stop.

As in the first exemplary embodiment, the present exemplary embodiment relates to a wireless communication system for vehicles that performs wireless communication for locking or unlocking doors of a vehicle between an on-board device mounted on the vehicle and a portable device (electronic key) carried by a user. In the wireless communication system for vehicles that executes wireless communication between the on-board device and the portable device, two communication sequences are defined as in the first exemplary embodiment.

The smart communication in the portable device may be required to stop for the purposes of suppressing battery consumption in the portable device and taking a measure against relay attack. However, the stop of the smart communication without the user's intent causes inconvenience to the user as described above. To suppress the occurrence of unintended stop of the smart communication, in the wireless communication system for vehicles according to the present exemplary embodiment, the smart communication is stopped in the case in which, with the vehicle in the locked state, the door locking is performed by the keyless communication and the smart communication is performed in sequence.

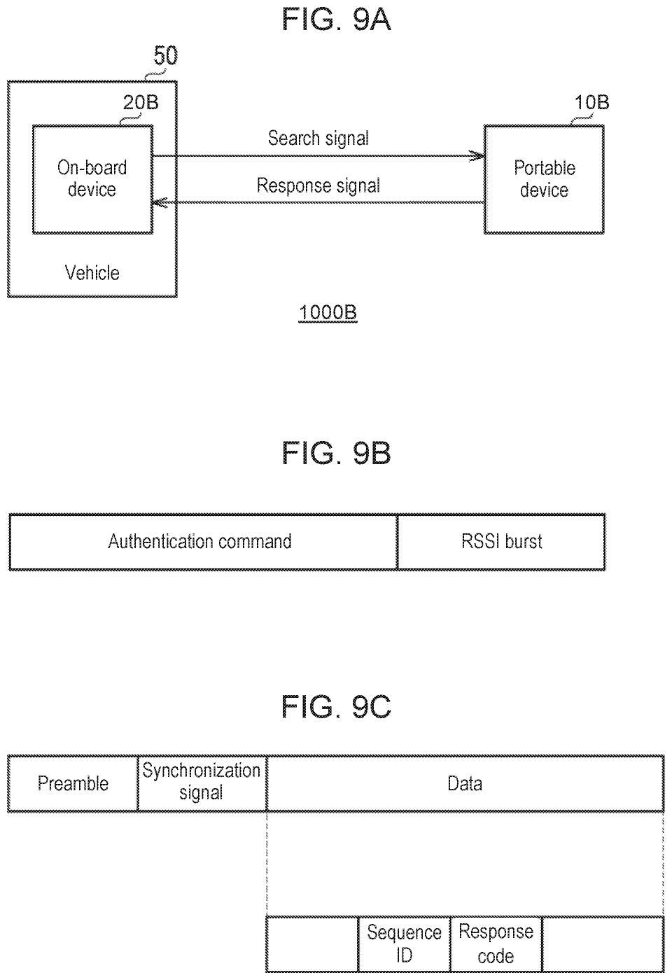

FIGS. 9A to 9C illustrate an outline of the smart communication performed by wireless communication system for vehicles 1000B. FIG. 9A illustrates an unlocking operation performed by wireless communication system for vehicles 1000B. Wireless communication system for vehicles 1000B includes portable device 10B and on-board device 20B. On-board device 20B is mounted on vehicle 50. When doors of vehicle 50 are locked, a user carrying portable device 10B, that is, a user who is going to board vehicle 50 touches a door knob of vehicle 50. With the door knob of vehicle 50 being touched as a trigger, on-board device 20B transmits a search signal to portable device 10B. The search signal and the communication distance are the same as those in the first exemplary embodiment.

FIG. 9B illustrates a format of the search signal. The search signal is the same as that in the first exemplary embodiment and thus descriptions of the search signal will be omitted.

As illustrated in FIG. 9A, upon receipt of the search signal from on-board device 20B, portable device 10B decrypts contents of an authentication command. When portable device 10B recognizes that the search signal is transmitted from authorized on-board device 20B based on a key ID included in the authentication command, portable device 10B transmits a response signal to on-board device 20B.

FIG. 9C illustrates a format of the response signal. The response signal disposes a preamble, a synchronization signal, and data in this order. The preamble and the synchronization signal are known signals used for establishing communication between portable device 10B and on-board device 20B. The data includes a sequence ID and a response code. The sequence ID is an ID for identifying a combination of on-board device 20B and portable device 10B, which is associated with the key ID. The response code is information indicating that this signal corresponds to the authentication command. Any publicly known technique is applicable to those codes, and therefore, description of those codes will be omitted herein.

As illustrated in FIG. 9A, on-board device 20B receives the response signal from portable device 10B. On-board device 20B determines whether a response to the already transmitted search signal has been received from portable device 10B, based on the sequence ID and the response code included in the response signal. When determining that the response signal has been received from portable device 10B, on-board device 20B unlocks the doors of vehicle 50. The same processing is performed for the locking of the doors of vehicle 50 mainly except that the content of the functional command is different.

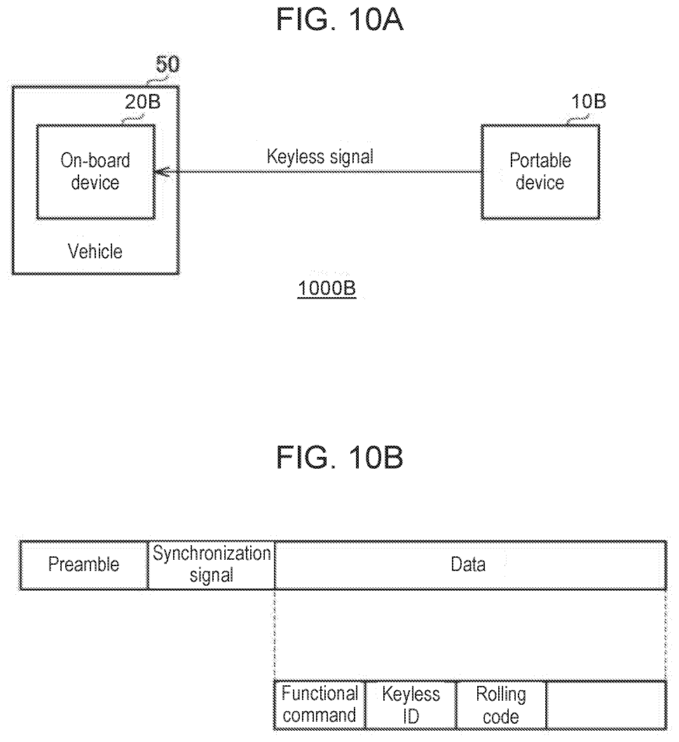

FIG. 10A illustrates an outline of keyless communication performed by wireless communication system for vehicles 1000B. When the user performs the operation for unlocking the doors, portable device 10B transmits a keyless signal to on-board device 20B. The operation for unlocking the doors performed by the user is, for example, to depress a button (not illustrated) provided in portable device 10B. Further, the keyless signal is a signal of a frequency band identical to that of the response signal.

FIG. 10B illustrates a format of the keyless signal. The keyless signal disposes a preamble, a synchronization signal, and data in this order. The preamble and the synchronization signal are the same as the preamble and the synchronization signal in the response signal. The data includes a functional command, a keyless ID code, and a rolling code. The functional command indicates information for specifying a function to be performed through the keyless communication, for example, an instruction for unlocking the doors. The keyless ID is an ID for identifying portable device 10B in the keyless communication, which is associated with the key ID on a one-to-one basis. The rolling code indicates a value that increases every transmission of the keyless signal from portable device 10B, and is represented with two bytes, for example. Specifically, the value of the rolling code increases by “1” every transmission of the keyless signal.

As illustrated in FIG. 10A, on-board device 20B receives the keyless signal. On-board device 20B determines whether to unlock the doors of vehicle 50 based on the keyless ID and the rolling code included in the keyless signal. The same processing is performed for the locking of the doors of vehicle 50 mainly except that the content of the functional command is different.

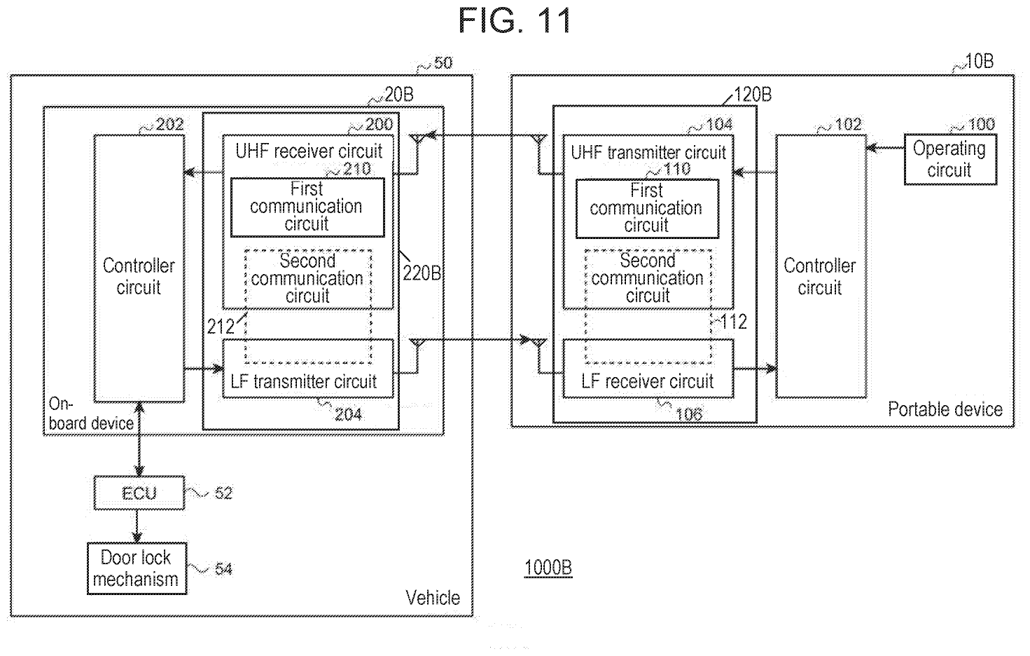

FIG. 11 is a functional block diagram illustrating a configuration of wireless communication system for vehicles 1000B. Wireless communication system for vehicles 1000B includes portable device 10B and on-board device 20B as described above. On-board device 20B is mounted on vehicle 50. Portable device 10B includes operating circuit 100, controller circuit 102, and communication circuit 120B. Communication circuit 120B includes UHF transmitter circuit 104 and LF receiver circuit 106. As described later, it can be regarded that communication circuit 120B includes first communication circuit 110 and second communication circuit 112. On-board device 20B includes controller circuit 202 and communication circuit 220B. Communication circuit 220B includes UHF receiver circuit 200 and LF transmitter circuit 204. As described later, it can be regarded that communication circuit 220B includes first communication circuit 210 and second communication circuit 212. Vehicle 50 includes electronic control unit (ECU) 52 and door lock mechanism 54.

Operating circuit 100 of portable device 10B is equivalent to a button used in the keyless communication. As an operation of requesting for locking the doors of vehicle 50, the user depresses this button. This case is based on the assumption that the locking of the doors is requested despite door lock mechanism 54 being already locked. When being depressed, operating circuit 100 notifies controller circuit 102 of the depression. Upon receipt of the notification from operating circuit 100, controller circuit 102 generates a keyless signal including a functional command for instruction for locking and a keyless ID. The format of the keyless signal is as described above. Controller circuit 102 outputs the keyless signal to UHF transmitter circuit 104. Upon receipt of the keyless signal from controller circuit 102, UHF transmitter circuit 104 transmits the keyless signal to on-board device 20B. In this manner, controller circuit 102 and UHF transmitter circuit 104 request on-board device 20B to lock the doors by the keyless signal including the keyless ID for identifying portable device 10B.

UHF receiver circuit 200 of on-board device 20B receives the keyless signal from portable device 10B. UHF receiver circuit 200 outputs the keyless signal to controller circuit 202. Upon receipt of the keyless signal from UHF receiver circuit 200, controller circuit 202 extracts the functional command, the keyless ID, and the rolling code from the keyless signal. Controller circuit 202 executes pair authentication based on the extracted keyless ID and the keyless ID retained in advance. Any publicly known technique only needs to be used for the pair authentication, and therefore, description of the pair authentication will be omitted herein. When the pair authentication has succeeded, controller circuit 202 determines whether the rolling code satisfies a predetermined condition. When the predetermined condition is satisfied, controller circuit 202 determines to execute the functional command. On the other hand, when the pair authentication has failed or when the rolling code does not satisfy the predetermined condition, controller circuit 202 determines not to execute the functional command.

When determining to execute the functional command, controller circuit 202 checks the state of door lock mechanism 54, that is, checks whether door lock mechanism 54 is in the locked state or the unlocked state. This state may be managed by controller circuit 202 or controller circuit 202 inquires about the state of door lock mechanism 54 via ECU 52. As described above, when door lock mechanism 54 is unlocked, that is, when the doors of vehicle 50 are not locked, controller circuit 202 locks door lock mechanism 54 via ECU 52 according to the instruction for locking indicated by the functional command. This is the unlocking by the general keyless communication, and thus the process is here terminated. Controller circuit 202 determines not to transmit a search signal in the smart communication.

On the other hand, when door lock mechanism 54 is locked, that is, when the doors of vehicle 50 are locked, controller circuit 202 determines to transmit the search signal in the smart communication if the instruction for locking is indicated by the functional command. Controller circuit 202 generates a search signal. At that time, the authentication command includes the key ID for identifying portable device 10B and a command for stopping the smart communication in portable device 10B. As described above, the key ID is associated with the keyless ID on a one-to-one basis, and the correspondence relationship is managed by controller circuit 202. Controller circuit 202 outputs the generated search signal to LF transmitter circuit 204. LF transmitter circuit 204 transmits the search signal to portable device 10B.

LF receiver circuit 106 of portable device 10B receives the search signal from on-board device 20B. LF receiver circuit 106 outputs the search signal to controller circuit 102. Controller circuit 102 extracts the key ID included in the search signal and the command for stopping the smart communication. Controller circuit 102 executes pair authentication based on an ID code retained in advance and the extracted key ID. When the pair authentication fails, a process described below is not executed. On the other hand, when the pair authentication has succeeded, controller circuit 102 generates a response signal and determines to stop the smart communication according to the extracted command. The stop of the smart communication will be described later. Controller circuit 102 outputs the response signal to UHF transmitter circuit 104. UHF transmitter circuit 104 transmits the response signal to on-board device 20B.

UHF receiver circuit 200 of on-vehicle device 20B receives the response signal from portable device 10B. When UHF receiver circuit 200 has not received a response signal for a specific period after the transmission of the search signal from LF transmitter circuit 204, controller circuit 202 may cause LF transmitter circuit 204 to transmit again the search signal.

When the one-way keyless communication from portable device 10B to on-board device 20B is called “first communication”, the two-way smart communication between portable device 10B and on-board device 20B is called “second communication”. First communication circuit 110 in UHF transmitter circuit 104 and first communication circuit 210 in UHF receiver circuit 200 are used for the keyless communication. Second communication circuit 112 in UHF transmitter circuit 104 and LF receiver circuit 106 and second communication circuit 212 in UHF receiver circuit 200 and LF transmitter circuit 204 are used for the smart communication. That is, first communication circuit 110 executes one-way first communication to on-board device 20B, and second communication circuit 112 executes two-way second communication with on-board device 20B. Similarly, first communication circuit 210 executes one-way first communication from portable device 10B, and second communication circuit 212 executes two-way second communication with portable device 10B.

When determining to stop the smart communication, controller circuit 102 of portable device 10B stops second communication circuit 112. Controller circuit 102 may cause second communication circuit 112 to transmit a response signal and then stop second communication circuit 112, or may stop second communication circuit 112 before causing second communication circuit 112 to transmit a response signal. In the latter case, no response signal is transmitted.

Next, a process for canceling the stop of second communication circuit 112 in portable device 10B will be described. Operating circuit 100 accepts an operation of a predetermined pattern. An example of an operation of a predetermined pattern is to alternately depress a button for unlocking and a button for locking five or more times. Operating circuit 100 notifies controller circuit 102 that the operation of a predetermined pattern has been accepted. Upon receipt of the notification from operating circuit 100, controller circuit 102 activates second communication circuit 112.

When the user gets in vehicle 50 and the engine is started by immobilizer communication, controller circuit 102 may activate second communication circuit 112. Any publicly known technique can be used for portable device 10B to recognize that the engine has been started by immobilizer communication. Thus description of the technique will be omitted. In addition, when a battery is attached to or detached from portable device 10B, controller circuit 102 may activate second communication circuit 112.

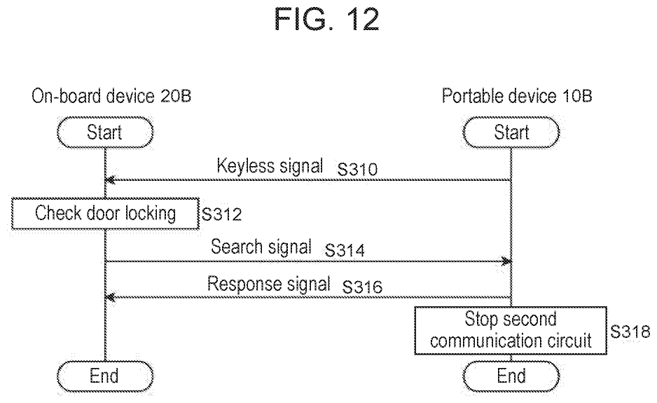

Operations of thus configured wireless communication system for vehicles 1000B will be described. FIG. 12 is a sequence diagram illustrating a stop procedure performed by wireless communication system for vehicles 1000B. When portable device 10B transmits a keyless signal (S310), on-board device 20B checks whether the doors are locked (S312) and transmits a search signal (S314). Upon receipt of the search signal, portable device 10B transmits a response signal (S316) and stops second communication circuit 112 (S318).

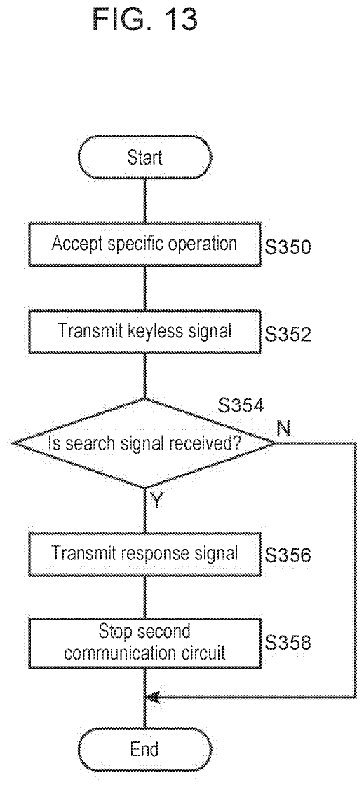

FIG. 13 is a flowchart illustrating a procedure for stopping second communication circuit 112 by portable device 10B. When operating circuit 100 accepts a specific operation for stopping second communication circuit 112 (S350), UHF transmitter circuit 104 transmits a keyless signal (S352). When LF receiver circuit 106 receives a search signal (Y in S354), UHF transmitter circuit 104 transmits a response signal (S356) and controller circuit 102 stops second communication circuit 112 (S358). When LF receiver circuit 106 does not receive a search signal (N in S354), the process is terminated.

As described above, when receiving the search signal from on-board device 20B after transmission of the keyless signal to on-board device 20B, portable device 10B stops second communication circuit 112 of portable device 10B. That is, second communication circuit 112 can be stopped by the user's intentional processing. Since second communication circuit 112 is stopped by the intentional processing, it is possible to suppress the occurrence of an unintentional stop. Since the search signal received by portable device 10B includes the command for stopping second communication circuit 112, second communication circuit 112 can be stopped according to the command. Since portable device 10B transmits the response signal to on-board device 20B and then stops second communication circuit 112 of portable device 10B, the response signal can be surely transmitted. Since portable device 10B transmits the response signal, the normal procedure for the smart communication can be executed. When accepting the operation of a predetermined pattern, portable device 10B activates second communication circuit 112, whereby second communication circuit 112 can be activated by a simple operation.

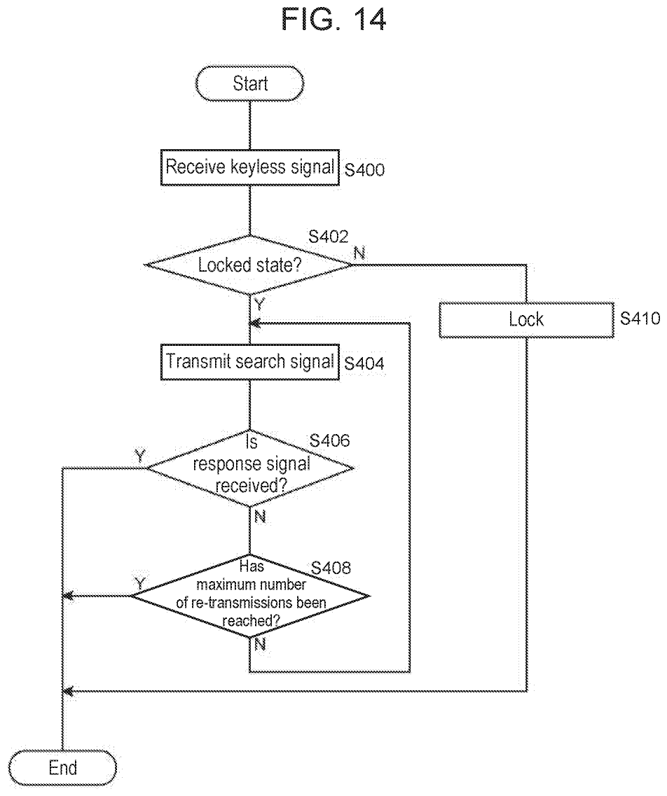

FIG. 14 is a flowchart illustrating a procedure for stopping second communication circuit 112 by on-board device 20B. UHF receiver circuit 200 receives a keyless signal for instructing for locking (S400). When door lock mechanism 54 is locked (Y in S402), LF transmitter circuit 204 transmits a search signal (S404). When UHF receiver circuit 200 does not receive a response signal (N in S406) and the maximum number of re-transmissions of the search signal has not been reached (N in S408), the process returns to S404. When UHF receiver circuit 200 has received the response signal (Y in S406) or when the maximum number of re-transmissions of the search signal has been reached (Y in S408), the process is terminated. When door lock mechanism 54 is not locked (N in S402), ECU 52 locks door lock mechanism 54 (S410).

As described above, upon keyless receipt of the signal from portable device 10B, on-board device 20B transmits a search signal to portable device 10B when the doors of vehicle 50 are locked. That is, on-board device 20B can transmit a search signal according to a procedure different from the normal processing. On-board device 20B transmits the search signal according to the procedure different from the normal processing, which allows the search signal to be used as an instruction signal for stopping second communication circuit 112 of portable device 10B. On the condition that the doors of vehicle 50 are locked, on-board device 20B can execute a process according to the user's intention. The transmitted search signal includes the command for stopping the smart communication, which allows on-board device 20B to stop the smart communication.

A portable device according to a second aspect of the present disclosure includes a first communication circuit, a second communication circuit, and a controller circuit. The first communication circuit executes one-way first communication to an on-board device, and the second communication circuit executes two-way second communication with the on-board device. After the first communication circuit transmits a signal (keyless signal), when the second communication circuit receives a signal (search signal) from the on-board device, the controller circuit stops the second communication circuit.

According to this aspect, after the signal is transmitted to the on-board device, when the signal from the on-board device is received, the second communication circuit is stopped, thereby making it possible to suppress the occurrence of an unintended stop.

The signal transmitted by the first communication circuit includes information for identifying the portable device. On the other hand, the signal received by the second communication circuit includes information for identifying the portable device and a command for stopping the second communication circuit. In this case, the received signal includes the command for stopping the second communication circuit, thereby making it possible to stop the second communication circuit.

After the first controller circuit transmits the signal to the on-board device, when the second communication circuit receives the signal from the on-board device, the controller circuit may cause the second communication circuit to transmit a response signal to the on-board device and then stop the second communication circuit. In this case, the second communication circuit is stopped after the transmission of the response signal to the on-board device, whereby the response signal can be surely transmitted.

The portable device may further have an operating circuit that, when the second communication circuit is stopped, accepts an operation from the user. When the operating circuit accepts an operation of a predetermined pattern, the controller circuit may activate the second communication circuit. In this case, the second communication circuit is activated when the operation of the predetermined pattern is accepted, thereby making it possible to activate the second communication circuit by a simple operation.

The on-board device according to the second aspect of the present disclosure includes the first communication circuit and the second communication circuit. The first communication circuit executes one-way first communication from the portable device, and the second communication circuit executes two-way second communication with the portable device. When an instruction for locking doors of a vehicle indicated by a signal (keyless signal) received by the first communication circuit matches state of the doors of the vehicle, the second communication circuit transmits a signal (search signal) to the portable device. On the other hand, when the instruction for locking the doors of the vehicle indicated by the signal received by the first communication circuit is different from the state of the doors of the vehicle, the second communication circuit does not transmit a signal (search signal) to the portable device.

According to this aspect, the signal is transmitted to the portable device when the instruction for locking the doors indicated by the signal from the portable device matches the state of the doors of the vehicle, thereby making it possible to transmit the signal according to a procedure different from the normal processing.

The instruction indicated by the signal received by the first communication circuit is to lock the doors. When the doors of the vehicle are locked, the second communication circuit may transmit a signal to the portable device, and when the vehicle is unlocked, the second communication circuit may not transmit a signal to the portable device. In this case, upon receipt of the signal from the portable device, when the doors of the vehicle are locked, the signal is transmitted to the portable device, thereby making it possible to transmit the signal according to the procedure different from the normal processing.

The signal received by the first communication circuit includes the information for identifying the portable device, and the signal transmitted by the second communication circuit includes the information for identifying the portable device and the command for stopping the second communication in the portable device. In this case, the transmitted signal includes the command for stopping the second communication circuit, thereby making it possible to stop the second communication circuit.

The present disclosure has been described so far according to the first and second exemplary embodiments. It will be understood by those skilled in the art that these exemplary embodiments are merely examples, other exemplary modifications in which components and/or processes of the exemplary embodiments are variously combined are possible, and the other exemplary modifications are still fall within the scope of the present disclosure.

In the first and second exemplary embodiments, for example, UHF transmitter circuit 104 and UHF receiver circuit 200 use UHF signals. However, the present disclosure is not limited this configuration. For example, a signal other than the UHF signal and of a frequency higher than the LF may be used. This modification can improve the degree of freedom in the configuration.

In the first exemplary embodiment, upon accept of the specific operation for stopping the smart communication, controller circuit 102 of portable device 10A generates a response signal including the communication stop information. However, the present disclosure is not limited to this. For example, when detecting that the reception strength of the search signal from on-board device 20A is less than or equal to the threshold (the first threshold), controller circuit 102 may generate a response signal including an instruction for stopping the smart communication (hereinafter, called “communication stop instruction”). Upon receipt of the communication stop instruction, controller circuit 202 of on-board device 20A stops communication in communication circuit 220A. According to the modification, it is possible to eliminate the need for comparison between the reception strength of the search signal and the first threshold by controller circuit 202 of on-board device 20A.

In the second exemplary embodiment, when the keyless signal includes the instruction for locking and door lock mechanism 54 is locked, on-board device 20B transmits the search signal. However, the present disclosure is not limited to this. For example, when the keyless signal includes an instruction for unlocking and door lock mechanism 54 is unlocked, on-board device 20B may transmit the search signal. That is, when there is a match between the instruction for locking the doors of vehicle 50 indicated by the keyless signal and the state of the doors of vehicle 50, on-board device 20B may transmit the search signal, and when there is no match, on-board device 20B may not transmit the search signal. This modification can improve the degree of freedom in the configuration.

The configuration of the first exemplary embodiment may be combined with the configuration of the second exemplary embodiment. In this case, the convenience of the smart entry system can be further improved.

According to the portable device, the on-board device, and the wireless communication system for vehicles of the present disclosure, it is possible to ensure the convenience even when the communication in the smart entry system is stopped.

What is claimed is:

1. A portable device performing two-way communication with an on-board device, the portable device comprising:
an operating circuit that accepts an operation for stopping communication with the on-board device;
a communication circuit that receives a first signal from the on-board device and transmits a second signal to the on-board device, the second signal including information on reception strength of the first signal and information on communication stop corresponding to the operation accepted by the operating circuit; and
a controller circuit that, when the reception strength of the first signal received by the communication circuit is less than or equal to a first threshold, causes the communication circuit to stop the communication with the on-board device.

2. The portable device according to claim 1, wherein, when the reception strength of the first signal received by the communication circuit is less than or equal to the first threshold, the controller circuit causes the communication circuit to transmit the second signal and then causes the communication circuit to stop the communication with the on-board device.

3. The portable device according to claim 1, wherein the first threshold is smaller than a second threshold in the reception strength of the first signal, the second threshold being a threshold for a vehicle equipped with the on-board device to lock a door of the vehicle.

4. An on-board device that is mounted on a vehicle to perform two-way communication with a portable device, the on-board device comprising:
a transmitter circuit that transmits a first signal to the portable device;
a receiver circuit that receives from the portable device a second signal including information on reception strength in a case where the portable device has received the first signal; and
a controller circuit that, when the second signal received by the receiver circuit includes information on stop of communication with the on-board device and the reception strength included in the second signal received by the receiver circuit is less than or equal to a first threshold, causes at least one of the transmitter circuit and the receiver circuit to stop communication with the portable device, and when the reception strength of the second signal received by the receiver circuit is less than or equal to a second threshold larger than the first threshold, instructs the vehicle to lock doors.

5. A wireless communication system for vehicles, the wireless communication system comprising:
an on-board device that transmits a first signal; and
a portable device that transmits to the on-board device a second signal including information on reception strength of the first signal received from the on-board device, wherein
when accepting an operation for stopping communication with the on-board device from an user, the portable device transmits to the on-board device the second signal including information on communication stop corresponding to the accepted operation, and when the reception strength of the received first signal is less than or equal to a first threshold, stops the communication with the on-board device.

6. The wireless communication system for vehicles according to claim 5, wherein, in a vehicle equipped with the on-board device, a door of the vehicle is locked when the reception strength of the first signal included in the second signal received by the on-board device is less than or equal to a second threshold larger than the first threshold.

7. The portable device according to claim 2, wherein the first threshold is smaller than a second threshold in the reception strength of the first signal, the second threshold being a threshold for a vehicle equipped with the on-board device to lock a door of the vehicle.
